(19) United States
(12) Patent Application Publication
(10) Pub. No.: US 2024/0025253 A1
(43) Pub. Date: Jan. 25, 2024

(54) APPARATUS AND METHOD FOR PROVIDING INFORMATION AND ENTERTAINMENT IN A MOTOR VEHICLE

(71) Applicant: Continental Automotive Technologies GmbH, Hannover (DE)

(72) Inventors: Thomas Gallner, Regensburg (DE); Marc Thom, Gevelsberg (DE); Antonio Avitabile, Florence (IT); Thorsten Köhler, Deuerling (DE)

(73) Assignee: Continental Automotive Technologies GmbH, Hannover (DE)

(21) Appl. No.: 18/224,417

(22) Filed: Jul. 20, 2023

(30) Foreign Application Priority Data
Jul. 22, 2022 (DE) 10 2022 207 506.4

(51) Int. Cl. B60K 35/00; B60W 40/08

(52) U.S. Cl. CPC B60K 35/00; B60W 40/08; B60K 2370/164; B60K 2370/73; B60W 2540/229; B60W 2540/22; B60W 2540/043

(57) ABSTRACT

A method for providing information and entertainment in a motor vehicle comprising ascertaining conditions within a passenger compartment of the motor vehicle, ambient conditions around the motor vehicle and operating parameters of the motor vehicle, evaluating information about a state of a first passenger and selecting information and/or entertainment from a result, and providing the information and/or entertainment selected for the first passenger is disclosed.

### CROSS REFERENCE TO RELATED APPLICATION

This U.S. patent application claims the benefit of German patent application No. 10 2022 207 506.4, filed Jul. 22, 2022, which is hereby incorporated by reference.

### TECHNICAL FIELD

The disclosure relates to an apparatus and a method for providing information and entertainment in a vehicle, so-called “in car content”.

The method according to the disclosure can be used both for autonomously driving vehicles and for conventional vehicles. Therefore, the text below refers to a first passenger, which, in conventional vehicles, corresponds to the vehicle driver.

### BACKGROUND

The prior art discloses broadcast radio receivers and broadcast radio reception, other multimedia devices and the use thereof, online streaming and services with simple personalization, such as for example Spotify, for use in a motor vehicle. A disadvantage with broadcast radio devices is that personalization is possible only to a very restricted degree by selecting radio stations that may currently be received and the range of which is limited, which means that on a longer journey it may be necessary to search for and select a different radio station. Other multimedia devices, such as for example mp3 players, may already better match the personal preferences of a first passenger, in particular of the vehicle driver required in conventional vehicles and/or his/her passengers, but are firmly predefined and may be changed only with effort. The same applies to online streaming services, which, although offered for different musical tastes, may never be tailored perfectly to a user. Finally, certain pieces of music may be sought in streaming services. A disadvantage of all of the known methods is that the first passenger is distracted when he/she changes the station or playlist while driving. This increases the risk of an accident in the case of vehicles that are not driving autonomously. It is almost irresponsible of a first passenger in a non-autonomous vehicle if he/she searches for pieces of music while driving and is thus distracted to such an extent that the risk of a road accident is greatly increased.

It is therefore an object of the disclosure to specify a method in which the first passenger is provided with personalized information and entertainment without being distracted from the traffic. This object is achieved by a method having the features of patent claim 1. Advantageous configurations can be inferred from the subclaims.

### SUMMARY

Since a first step comprises ascertaining the conditions within the passenger compartment of the motor vehicle, the ambient conditions around the motor vehicle and operating parameters of the motor vehicle, a second step comprises ascertaining information about the state of a first passenger and a third step comprises evaluating the information ascertained in the first step and the second step and selecting information and/or entertainment from the result and providing said information and/or entertainment for the first passenger, it is possible to provide information and/or entertainment that is acceptable to the first passenger, since this information and/or entertainment is tailored to the general situation of the motor vehicle and the first passenger, that is to say a vehicle driver, when the method according to the invention is used in a conventional motor vehicle. The information that is output may be educational programs, weather reports, political events or market prices, for example. The entertainment provided may be pieces of music or radio plays, for example, that are tailored to the situation. If for example a camera is used to detect that the vehicle driver is tired, he/she may be provided with or played more exciting pieces of music. If it is detected that the motor vehicle driver is excited, more calming pieces of music will be provided, that is to say played back, in order to calm the vehicle driver and thus prompt a safe driving style from him/her, without the vehicle driver being aware of this.

If the second step also comprises evaluating information about the state and/or behavior of any further passengers, the selection of the information and/or entertainment to be provided may be improved, since firstly the effect of the further passengers on the first passenger is also factored into the decision regarding what information and/or entertainment is/are provided. If the vehicle driver is tense as a result of the behavior of the other passengers, for example, it is useful to provide calming pieces of music in order to ease the situation within the motor vehicle and not to inflame it further.

If the third step also comprises evaluating information about the state of any further passengers and providing information and/or entertainment for the first passenger and the further passengers from the result, the satisfaction of all the passengers allows the situation within the vehicle to be perceived positively by all the passengers and thus allows driving safety and comfort to be improved. If for example one or more children are present as further passengers, it appears useful to provide child-friendly information and/or entertainment, for example children's songs or radio plays for children. It is also possible to provide the other passengers with videos or games as entertainment, but to provide the first passenger with these only when he/she does not need to perform any active driving tasks for the motor vehicle for the foreseeable future, that is to say when the motor vehicle is in an autonomous driving mode.

If the reactions of the first passenger and of any further passengers to the information and/or entertainment provided are ascertained and stored in a storage medium and taken into consideration for a subsequent selection of information and/or entertainment to be provided, the selection of information and/or entertainment to be provided may be continually improved, since the method detects how the individual information and/or entertainment affects the passenger or the passengers.

If the first passenger is identified using biometric features, for example, and is associated with the information stored about him/her, then subsequent use of the method at a later time, when the first passenger and/or the further passengers is/are recognized, may involve the information being taken into consideration for a subsequent selection of information and/or entertainment to be provided and the selection being improved in this way.

If the preferences of the first passenger and/or the further passenger(s) for information and/or entertainment may be input, the selection of the appropriate information and/or entertainment offered has a high probability of being ensured from the beginning of use of the method according to the disclosure. This input may be made manually using a keypad or by voice using a voice recognition system, for example.

If the first step also comprises ascertaining data of a map, the selection of the information and/or entertainment to be output may be improved further.

The method according to the disclosure may be improved even further if the first step also comprises ascertaining the current location of the motor vehicle and a destination for the current journey.

If these distances travelled are stored and taken into consideration in the second step during subsequent methods according to the invention, the result found may be improved further.

If the first step comprises registering at least one of the states of the flow of traffic that the motor vehicle is in, the driving task, the navigation directions, the driving time already required, the driving time probably required to the destination and/or the current whereabouts of the motor vehicle, the selection of the information and/or entertainment may be improved even further.

If the first step comprises registering at least one of the operating parameters: vehicle speed, engine speed, energy reserve, engine oil temperature, yaw rate, tire pressure or acceleration, this information may also be used to detect the driving style of the vehicle driver and, for example if the driving is aggressive, calming information and/or entertainment is provided.

If the information in the second step comprises at least information concerning the tiredness, emotion, mood, excitation, stress, attentiveness, intoxication, age and/or sex of the first person, the provision of information and/or entertainment may be improved further. Information concerning tiredness, emotion, mood, excitation, stress and/or attentiveness may be provided for example on the basis of an evaluation of an image from the camera that is present in the motor vehicle.

Furthermore, the method may be improved when the information in the second step about the state of the further persons comprises at least information about the behavior of the further persons and/or about the atmosphere between the persons. This information may also be provided using one or more evaluations of images generated by one or more cameras that are present in the motor vehicle. When a microphone is present, it is also or additionally possible to use voice recognition to evaluate the content of the conversation held between the passengers and thus to infer the atmosphere that exists.

If the first step comprises performing at least one of the following actions: recording the passenger compartment of the motor vehicle by means of a 2D or 3D camera or radar or lidar, recording sounds and/or ascertaining gases in the passenger compartment of the motor vehicle, the situation in the passenger compartment may be analyzed even more precisely. As such, for example restless children may be ascertained and the offer of entertainment selected in such a way that the restless children are calmed.

In summary, it may be stated that taking into consideration as many influences as possible that affect the wellbeing of the first passenger and/or of the further passengers helps to improve the selection of the information and/or entertainment provided.

The method described above may be used in a multimedia system that is present in the motor vehicle. It is also possible for it to be used in a portable device, for example a smartphone, if this portable device either generates the requisite information itself (camera and/or microphone, or GPS sensor, installed in the device) or may receive it from the sensors installed in the vehicle, including a camera or cameras, by virtue of its being connected to the vehicle by plug connection, cable or wirelessly, for example using Bluetooth or WiFi, and the connection for the individual sensors being connected for example via a bus system of the vehicle or individual lines of the vehicle receiving and evaluating, and playing back the received results via the multimedia system of the motor vehicle.

### BRIEF DESCRIPTION OF THE FIGURES

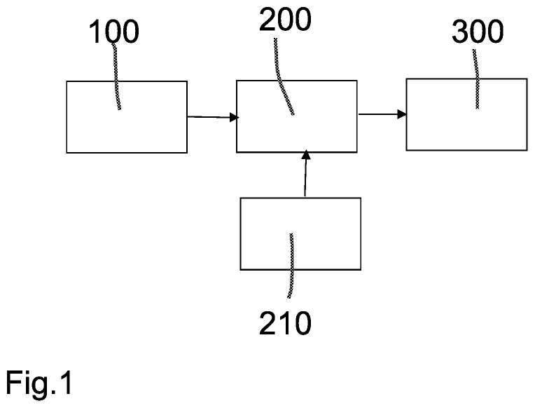

An exemplary embodiment of the method according to the disclosure is explained in more detail below with reference to FIG. 1.

### DETAILED DESCRIPTION

A first step 100, a second step 200, having a memory reading step 210, and a third step 300 may be seen.

The first step 100 comprises collecting as many current data as possible, as described above, for example by one or more cameras, one or more microphones, one or more temperature sensors, one or more pressure sensors and/or gas monitoring sensors, in each case for monitoring the passenger compartment of the motor vehicle, one or more cameras, one or more thermometers, a GPS system and/or a navigation system, in each case for monitoring the surroundings of the motor vehicle, and the current operating data of the motor vehicle that are available in the motor vehicle. The second step 200 comprises evaluating these ascertained data, for example ascertaining the number and behavior of the passengers that are present in the passenger compartment, for example by way of image evaluation from the available recordings of the interior, the evaluation of the recorded sounds or the evaluation of pressure sensors that are present in seats of the motor vehicle. If available, the data already available for the first passenger and/or further passengers are also read in step 210 and taken into consideration when evaluating the currently ascertained data. The data read in step 210 may comprise data from preferences of the first passenger and/or of the further passengers for specific styles of music, pieces of music and/or preferred information content. Personal association of the passengers is possible by way of biometric sensing and determination, for example. Personalized entry systems for the motor vehicle also result in association being possible using these systems. The data read in step 210 may also encompass other earlier events, such as for example the distances covered by individual vehicle drivers who have used the motor vehicle. The data read in step 210 may then be taken into consideration to evaluate the current data, which means that the result will probably become even better. Step 300 then comprises providing the results ascertained in step 200 to the passengers, for example playing back pieces of music or presenting audible information. Videos or computer games may also be provided for passengers who do not need to perform any driving tasks for the motor vehicle for the foreseeable future.

1. A method for providing information and entertainment in a motor vehicle, the method comprising:
ascertaining conditions within a passenger compartment of the motor vehicle, ambient conditions around the motor vehicle and operating parameters of the motor vehicle;
evaluating information about a state of a first passenger and selecting information and/or entertainment from a result; and
providing the information and/or entertainment selected for the first passenger.

2. The method as claimed in claim 1, further comprising evaluating information about a state and/or behavior of any further passengers.

3. The method as claimed in claim 2, further comprising providing information and/or entertainment for the first passenger and the further passengers from the result.

4. The method as claimed in claim 2, wherein reactions of the first passenger and any further passengers to the information and/or entertainment provided are ascertained and stored in a storage medium and taken into consideration by a memory reading step for a subsequent selection of information and/or entertainment to be provided.

5. The method as claimed in claim 4, wherein the first passenger is identified and is associated with the information stored, which is taken into consideration by the memory reading step for a subsequent selection of information and/or entertainment to be provided.

6. The method as claimed in claim 2, wherein preferences of the first passenger and/or of the further passenger(s) for information and/or entertainment is input.

7. The method as claimed in claim 1, further comprising ascertaining data of a map.

8. The method as claimed in claim 7, further comprising ascertaining a current location of the motor vehicle and a destination for a current journey.

9. The method as claimed in claim 8, wherein distances travelled are stored and are taken into consideration by a memory reading step during subsequent selection of information and/or entertainment.

10. The method as claimed in claim 1, further comprising registering at least one of the states of a flow of traffic that the motor vehicle is in, a driving task, navigation directions, a driving time already required, a driving time probably required to a destination and/or a current whereabouts of the motor vehicle.

11. The method as claimed in claim 1, further comprising registering at least one of the operating parameters: vehicle speed, engine speed, energy reserve, engine oil temperature, yaw rate, tire pressure or acceleration.

12. The method as claimed in claim 1, wherein evaluating information about the state of the first passenger encompasses at least information concerning the tiredness, emotion, mood, excitation, stress, attentiveness, intoxication, age and/or sex of the first passenger.

13. The method as claimed in claim 2, wherein evaluating information about the state and/or behaviour of any further passengers encompasses at least information about the behavior of the further passengers and/or about the atmosphere between the passengers.

14. The method as claimed in claim 1, further comprising performing at least one of the following actions: recording the passenger compartment of the motor vehicle by a 2D or 3D camera or radar or lidar, recording sounds and/or ascertaining gases in the passenger compartment of the motor vehicle.
